(19) United States
(12) Patent Application Publication
(10) Pub. No.: US 2006/0005398 A1
(43) Pub. Date: Jan. 12, 2006

(54) Device for removing a pharmaceutical dosage unit from a unit package

(76) Inventors: Steve Sramek, Long Beach, CA (US); Larry Calderon, Duarte, CA (US)

Correspondence Address: ARNOLD & PORTER LLP;ATTN: IP DOCKETING DEPT., 555 TWELFTH STREET, N.W., WASHINGTON, DC, 20004-1206, US

(21) Appl. No.: 10/887,866

(22) Filed: Jul. 12, 2004

(51) Int. Cl. B26B 3/00

(52) U.S. Cl. 30/278

(57) ABSTRACT

The present invention is directed to a pharmaceutical unit package opener, which is a device for removing a pharmaceutical dosage unit, such as a pill or capsule, from a pharmaceutical unit package. In particular, the present invention is directed to a device for removing a pharmaceutical dosage unit from a unit package that cannot be opened manually. The present invention is also directed to a device for removing a pharmaceutical dosage unit from a unit package that can also be opened manually.

### FIELD OF THE INVENTION

The present invention is directed to a device for removing a pharmaceutical dosage unit, such as a pill or capsule, from a pharmaceutical unit package (e.g., a blister pack). In particular, the present invention is directed to a device for removing a pharmaceutical dosage unit from a unit package that cannot be opened manually. The present invention is also directed to a device for removing a pharmaceutical dosage unit from a unit package that can also be opened manually.

### BACKGROUND

Pharmaceutical unit packages (e.g., blister packs) encompass a variety of types of packaging that consist of individually enclosed single pharmaceutical dosage units, such as pills, capsules, caplets, liquid capsules, powder, or other medication dosage forms. Unit packages are designed to hold and segregate individual pharmaceutical dosage units and to enable their individual release. One example of a unit package is a blister pack, which may have a relatively flat backing comprised of foil or paper and a front side comprised of a more rigid material that is shaped into one or more blister pack wells designed to hold individual pharmaceutical dosage units. A pharmaceutical dosage unit (e.g., a pill) may be released from this type of blister pack by applying manual pressure to a blister pack well on the more rigid side, which causes the blister pack well to deform, thereby allowing the pharmaceutical dosage unit to be manually forced through the foil backing. In another type of blister pack, a pharmaceutical dosage unit is released by pulling a tab, typically a corner, of the blister pack backing, thereby removing the portion of the package backing that had sealed the blister pack well, and releasing the pharmaceutical dosage unit.

Some force and manual dexterity are required to release a pharmaceutical dosage unit from a unit package, and as such unit packages can be difficult to open, particularly for individuals having arthritis or other impairments of the hands. For this reason, there is a need for tools that assist in the opening of unit packages. In addition, such a tool would enable design of a modified unit package with child-resistant properties, such as, for example, a unit package in which an individual pharmaceutical dosage unit cannot be released by manual pressure alone, but rather must be opened with the aid of a puncturing tool or opener.

The above-described combination of a tool and a modified unit package is particularly appropriate for packaging pharmaceutical dosage units that are hazardous if ingested or handled by children. In addition, such a combination of a tool and a modified unit package is a method to limit patients' and caregivers' exposure to, and incidental handling of, pharmaceutical dosage units that may be harmful to the skin of the hands. Moreover, for health care workers who must open many unit packages at one time, e.g., to provide medication to many patients in a hospital setting, the use of an opening tool has the advantages of reducing repetitive hand motion and strain on the hands, and of increasing the speed of package opening.

U.S. Pat. No. 5,853,101, issued to Jack Weinstein and assigned on its face to Primary Delivery Systems, Inc., describes an opener for soft packs of medication with individual dosage opening capabilities (e.g., blister packs). The device comprises a base segment and a top segment, at least a portion of which are hingedly connected to one another. The top segment of the device has a puncture mechanism thereon, and the base segment of the device has an orifice therein which is of a respective size to receive a corresponding dosage unit section of a soft pack. The puncture mechanism has a puncture mechanism protrusion of a predetermined height that relates to the dimensions of the soft pack backing and a dosage unit (e.g., a pill). The predetermined height of the puncture mechanism protrusion is selected so as to puncture the soft pack backing and so as to retain space between the puncture mechanism protrusion and the dosage unit when the dosage unit section is placed within the orifice of the bottom segment while the top segment is hingedly pushed downwardly. The device creates a short cut in the soft pack backing through which the dosage unit can be pushed.

In contrast to the device described in U.S. Pat. No. 5,853,101, the present invention lacks a hinge and is therefore easier to manufacture. In addition, the present invention lacks a puncture mechanism protrusion having a predetermined height selected so as to retain space between the puncture mechanism protrusion and the dosage unit (e.g., pill). Therefore, the present invention can be used to open unit packages holding pharmaceutical dosage units of various heights, without the need for modification of the height of the puncture mechanism.

### SUMMARY OF THE INVENTION

The present invention includes a unit package opener, which comprises a puncture mechanism, a top segment and a base segment, at least a portion of the top segment and the base segment being rigidly connected to one another, the base segment having an indentation therein which is of a size to receive a unit package enclosure, and the top segment having the puncture mechanism located thereon, where the puncture mechanism is shaped to have a larger perimeter than the perimeter of the pharmaceutical dosage unit and further shaped to nest within the indentation, where the top segment, or the base segment, or both, comprise a flexible material, and where the application of manual pressure to the top segment or base segment, or both, results in bringing the puncture mechanism into contact with and cutting the unit package enclosure, such that the unit package enclosure is pierced, and the pharmaceutical dosage unit is released.

The present invention also includes a blister pack opener, which comprises a puncture mechanism, a top segment and a base segment, at least a portion of the top segment and the base segment being rigidly connected to one another, the base segment having an indentation therein which is of a size to receive a blister pack well that encloses a pharmaceutical dosage unit, and the top segment having the puncture mechanism located thereon, where the puncture mechanism is shaped to have a larger perimeter than the perimeter of the pharmaceutical dosage unit and further shaped to nest within the indentation, where the top segment, or the base segment, or both, comprise a flexible material.

The present invention also includes a blister pack opener, which comprises a puncture mechanism, a top segment and a base segment, at least a portion of the top segment and the base segment being rigidly connected to one another, the base segment having an indentation therein which is of a size to receive a blister pack well that encloses a pharmaceutical dosage unit, and the top segment having the puncture mechanism located thereon, the puncture mechanism having a metal cutting edge and having one or more protrusions with blunted ends to enhance puncturing of the blister pack backing, where the puncture mechanism is circular and is shaped to have a larger perimeter than the perimeter of the pharmaceutical dosage unit and further shaped to nest within the indentation, where the indentation has a circular shape and a flat bottom, where the top segment or the base segment, or both, comprise a flexible plastic material, where the top segment or the base segment, or both, have one or more protrusions to enhance positioning of a blister pack when the opener is in use, and where application of manual pressure to the top segment and the base segment results in flexion near a distal end of the top segment or the base segment or both, thereby bringing the puncture mechanism into contact with and cutting the blister pack backing, such that the blister pack backing is pierced.

The present invention also includes a method of opening a blister pack, the method comprising placing a blister pack into a device comprising a puncture mechanism, a top segment and a base segment, at least a portion of the top segment and the base segment being rigidly connected to one another, the base segment having an indentation therein which is of a size to receive a blister pack well that encloses a pharmaceutical dosage unit, and the top segment having the puncture mechanism located thereon, where the puncture mechanism is shaped to have a larger perimeter than the perimeter of the pharmaceutical dosage unit and further shaped to nest within the indentation, where the top segment, or the base segment, or both, comprise a flexible material, where the blister pack is placed into the device such that the blister pack well is placed within the indentation of the device, and applying manual pressure to the top segment and the base segment of the device, and bringing the puncture mechanism into contact with and cutting the blister pack backing, such that the blister pack backing is pierced.

### BRIEF DESCRIPTION OF THE DRAWINGS

FIG. 1 sets forth an oblique side view of a blister pack opener.

FIG. 2 sets forth a top view of a blister pack opener.

FIG. 3 sets forth a lengthwise side view of a blister pack opener.

FIG. 4 sets forth a side view of a first cutting portion of a blister pack opener.

FIG. 5 sets forth a side view of a second cutting portion of a blister pack opener.

### DETAILED DESCRIPTION OF THE INVENTION

Definitions

A “pharmaceutical dosage unit” comprises a medication dosage form, such as a pill, capsule, caplet, liquid capsule, powder, or other dosage form.

A “unit package” comprises any type of packaging in which pharmaceutical dosage units are packaged such that they are individually segregated and may be individually released from the package. Unit packages may include, but are not limited to, blister packs, plasticpacks, paperpacks, foil packs, metal packs, soft packs, and packs using a combination of materials.

A “unit package enclosure” comprises a portion of a unit package that is shaped to contain and thereby segregate an individual pharmaceutical dosage unit.

A “blister pack well” comprises a portion of a blister pack that is shaped to contain and thereby segregate an individual pharmaceutical dosage unit.

Description

The present invention comprises a device for removing a pharmaceutical dosage unit from a unit package (i.e., a unit package opener). In one embodiment, an opener of the present invention is used in connection with a unit package that cannot be opened manually. In another embodiment, an opener of the present invention is used in connection with a unit package that can also be opened manually.

Unit packages are designed to hold and segregate individual pharmaceutical dosage units and to enable their individual release. One example of a unit package is a blister pack, which may have a relatively flat backing comprised of a thin foil, or another easily punctured material, and a front side comprised of a more rigid material that is shaped into one or more blister pack wells designed to hold individual pharmaceutical dosage units. In one type of blister pack, a blister pack well comprises a depression in a more rigid front side of a blister pack, which depression is an appropriate size to enclose a pharmaceutical dosage unit; containment and segregation of the pharmaceutical dosage unit within the blister pack well may be accomplished by affixing a backing material, e.g., a foil backing, to the more rigid front side of the blister pack. For this type of blister pack, the backing comprises a material that can be punctured, either by applying manual pressure to the more rigid side of the blister pack, or through the use of a blister pack opener. In some blister packs of this type, a pharmaceutical dosage unit is released from the blister pack by applying manual pressure to a blister pack well, which causes the blister pack well to deform, thereby allowing the pharmaceutical dosage unit to be manually forced through the blister pack backing. Alternatively, a blister pack opener may optionally be used, or may be required, to pierce the blister pack backing or release the pharmaceutical dosage unit from this type of blister pack.

In another type of blister pack, a pharmaceutical dosage unit is released by pulling a tab, typically a corner, of the blister pack backing, thereby removing the portion of the package backing that had sealed the blister pack well and releasing the pharmaceutical dosage unit. Alternatively, a blister pack opener may optionally be used, or may be required, to pierce the blister pack backing or release the pharmaceutical dosage unit.

In one embodiment of the present invention, a unit package opener is capable of opening a unit package that is not comprised of a more rigid side and a paper or foil backing; for example, a unit package opener of the present invention is capable of opening a plastic pack or a paper pack. In one embodiment, a unit package opener is used to burst or puncture the unit package enclosure. In another embodiment, operation of a unit package opener results in piercing of the unit package enclosure, or release of the pharmaceutical dosage unit, or both.

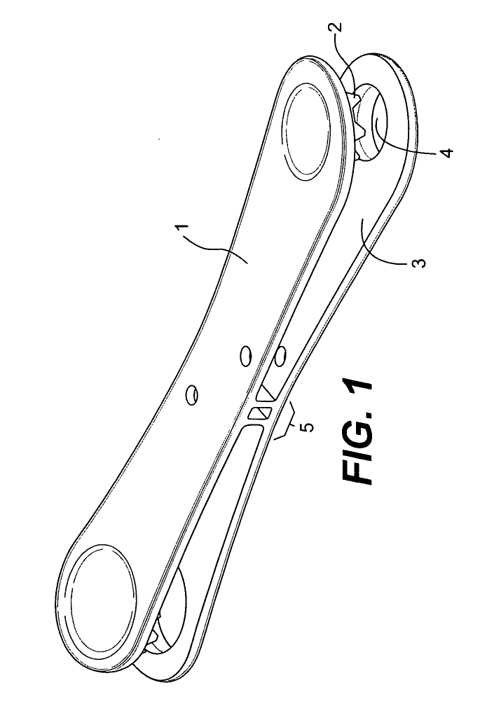

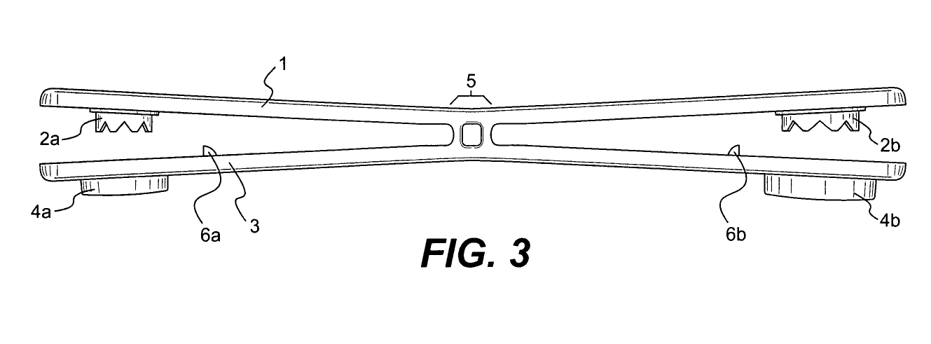

As shown in FIG. 1, in one embodiment, a blister pack opener comprises a top segment 1, upon which is located a puncture mechanism 2, and a base segment 3, which has an indentation 4 therein that is of a size to receive a blister pack well that encloses a pharmaceutical dosage unit. At least a portion of the top segment 1 and the base segment 3 are rigidly connected to one another by a rigid connecting portion 5. The top segment 1, or the base segment 3, or both, comprise a flexible material. The puncture mechanism is shaped to have a larger perimeter than the perimeter of the pharmaceutical dosage unit to be released, and further shaped to nest within the indentation 4. To operate the blister pack opener, a blister pack is placed between the top segment 1 and the base segment 3 such that a blister pack well is located within the indentation 4 of the base segment. In one embodiment, the top segment 1, or the base segment 3, or both, have one or more protrusions 6a, 6b to enhance positioning of a blister pack when the opener is in use (see, e.g., FIG. 3). In one embodiment, application of manual pressure to the top segment 1, the base segment 3, or both, results in bringing the puncture mechanism 2 into contact with and cutting the blister pack backing, such that the blister pack backing is pierced and said pharmaceutical dosage unit is released from said blister pack.

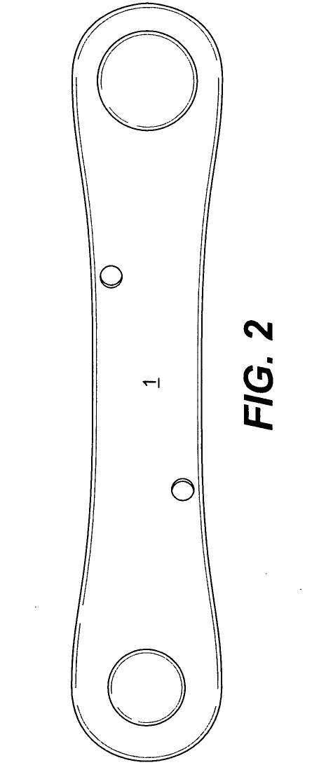

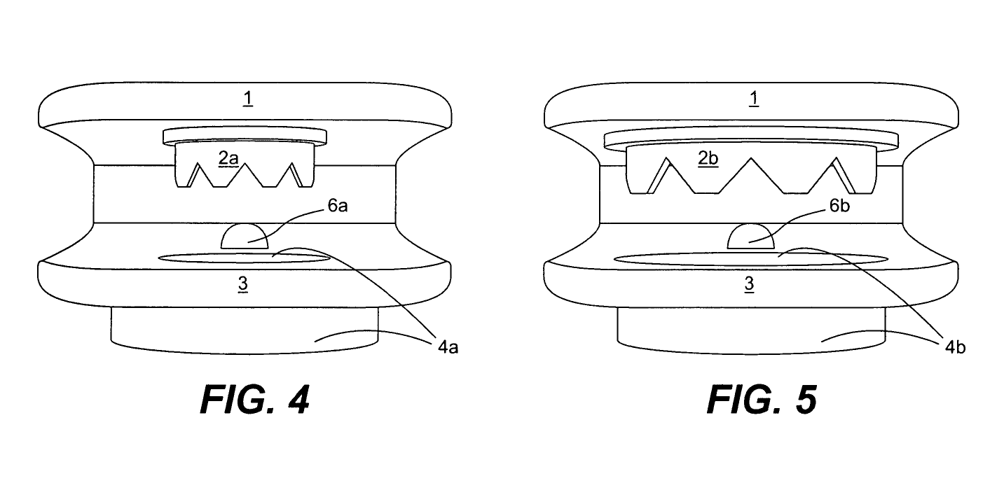

In one embodiment, a blister pack opener comprises more than one puncture mechanism. For example, as shown in FIGS. 2-5, a blister pack opener may comprise two puncture mechanisms 2a, 2b and two indentations 4a, 4b, with one puncture mechanism and one indentation located at each distal end. The top segment 1 and the base segment 3 are joined by a rigid connecting portion 5 at the midpoint of the top and bottom segments (FIG. 3). The two puncture mechanisms 2a, 2b and two indentations 4a, 4b, may have different perimeters in order to accommodate pharmaceutical dosage units of different sizes (see, e.g., FIGS. 4 and 5).

In one embodiment, application of manual pressure to the top segment, the base segment, or both, results in bringing at least a portion of the puncture mechanism into the indentation. In another embodiment, application of manual pressure results in at least a portion of the puncture mechanism nesting within the indentation. In another embodiment, application of manual pressure results in at least a portion of the puncture mechanism entering the space created by the indentation.

In one embodiment, the application of manual pressure to the top segment, the base segment, or both, results in flexion near a distal end of the top segment, the base segment, or both, thereby bringing at least a portion of the puncture mechanism into the indentation. In one embodiment, the application of manual pressure to the top segment, the base segment, or both, results in flexion near a distal end of the top segment, the base segment, or both, thereby causing least a portion of the puncture mechanism to nest within the indentation. In one embodiment, the application of manual pressure to the top segment, the base segment, or both, results in flexion near a distal end of the top segment, the base segment, or both, thereby causing least a portion of the puncture mechanism to enter the space within the indentation.

In one embodiment, application of manual pressure to the top segment, the base segment, or both, results in bringing the puncture mechanism into contact with and cutting the blister pack backing, such that the blister pack backing is pierced. In another embodiment, application of manual pressure to the top segment, the base segment, or both, results in bringing the puncture mechanism into contact with and cutting the blister pack backing, such that the blister pack backing is pierced, and such that the pharmaceutical dosage unit is released from the blister pack. In another embodiment, the blister pack opener is rotated slightly while manual pressure is applied to the top segment and base segment, which results in bringing the puncture mechanism into contact with and cutting the blister pack backing, such that the blister pack backing is pierced, and such that the pharmaceutical dosage unit is released.

In one embodiment, application of manual pressure to the top segment, the base segment, or both, results in flexion near a distal end of the top segment or the base segment, thereby bringing the puncture mechanism into contact with and cutting the blister pack backing, such that the blister pack backing is pierced, and such that the pharmaceutical dosage unit is released from the blister pack. In one embodiment, the blister pack backing is pierced such that a continuous cut is made around the perimeter of the pharmaceutical dosage unit. In another embodiment, the continuous cut made around the perimeter of the pharmaceutical dosage unit is circular, rectangular, or oval in shape.

In one embodiment, the rigid connecting portion of the blister pack opener has a single attachment between the top segment and the base segment. In another embodiment, the rigid connecting portion has two, three, four, or more attachments between the top segment and the base segment. In one embodiment, the rigid connecting portion or portions are located at the midpoint of the top segment and the base segment. In another embodiment, the rigid connecting portion is located at an end of the top segment and the base segment. In one embodiment, the top segment and base segment are rigidly connected such that application of manual pressure to the top segment, base segment, or both, close to the rigid connecting portion results in very little bending of the portions of the top segment or base segment that are near to the rigid connecting portion.

In one embodiment, the perimeter of the puncture mechanism can be varied in size in order to accommodate the release of pharmaceutical dosage units of various sizes. In another embodiment, a blister pack opener comprises a tool having multiple sections possessing different features (i.e., multiple blister pack puncturing units); for example, each of the multiple blister pack puncturing units may be optimized to release a pharmaceutical dosage unit of a particular size from a blister pack. In one embodiment, a blister pack opener comprises two blister pack puncturing units, where the top segment and the base segment are rigidly connected to one another at the midpoint of the top segment and the base segment, and where the base segment has a puncture mechanism located at each distal end. In another embodiment, the blister pack opener comprises two blister pack puncturing units, with the first blister pack puncturing unit comprising a first perimeter and the second blister pack puncturing unit comprising a second perimeter of a different size than the first perimeter, whereby the first perimeter and the second perimeter enable the first puncture mechanism and the second puncture mechanism to release pharmaceutical dosage units of different sizes.

In one embodiment, the puncture mechanism has a cutting edge. In another embodiment, the puncture mechanism has one or more protrusions to enhance puncturing of the blister pack backing when the blister pack opener is operated. In one embodiment, the protrusions have pointed ends; in another embodiment, the protrusions have blunted ends. In another embodiment, the puncture mechanism comprises a material of strength greater than the strength of the blister pack backing, in order that the puncture mechanism may puncture the blister pack backing. Preferably, the puncture mechanism comprises metal, including but not limited to stainless steel, steel, aluminum, copper, tin, lead, zinc, nickel, gold, silver, titanium and alloys. In other embodiments, the puncture mechanism may comprise plastic (including but not limited to polypropylenes, polystyrenes polyethylenes, polyamides, polyvinyl chlorides, polycarbonates, acrylics, resins, or ABS), ceramic or other materials.

In one embodiment, the puncture mechanism has a circular shape. In another embodiment, the puncture mechanism has a rectangular shape. In another embodiment, the puncture mechanism has an oval shape. In another embodiment, the puncture mechanism has a linear shape. In another embodiment, the puncture mechanism has a curvilinear shape.

In one embodiment, the indentation has a flat bottom. In another embodiment, the indentation has a concave bottom. In yet another embodiment, the indentation has a convex bottom. In one embodiment, the indentation has a circular shape. In another embodiment, the indentation has a rectangular shape. In another embodiment, the indentation has an oval shape. In one embodiment, the indentation has the same shape as the puncture mechanism. In another embodiment, the indentation has a different shape than the puncture mechanism.

In one embodiment, the top segment or base segment of the blister pack opener have one or more protrusions to enhance positioning of a blister pack when the opener is in use. For example, the one or more protrusions may prevent the blister pack from being inserted too far into the device, thereby assisting in properly aligning the blister pack well with the puncture mechanism.

The top segment or base segment, or both, of the blister pack opener may comprise a variety of materials. In a preferred embodiment, the top segment and base segment comprise plastic, including but not limited to polypropylenes, polystyrenes polyethylenes, polyamides, polyvinyl chlorides, polycarbonates, acrylics, resins, or ABS. In another embodiment, the top segment and base segment comprise metal, including but not limited to stainless steel, steel, aluminum, copper, tin, lead, zinc, nickel, gold, silver, titanium and alloys. In another embodiment, the top segment and base segment comprise wood, ceramic or other materials. In yet another embodiment, the top segment and base segment comprise different materials, each of which are selected from the group consisting of plastic, metal, wood, resin, ceramic or other materials. In a preferred aspect, such materials are capable of partially deforming in shape upon application of manual pressure to a top segment, or base segment, or both, that is comprised of such materials.

In one embodiment, the present invention comprises an opener that is formed as part of a package. For example, an opener of the present invention could be integrally formed with a blister pack, or not. In one embodiment, the present invention comprises a kit that comprises a unit package opener, and directions for using the unit package opener to release a pharmaceutical dosage unit from the unit package. In another embodiment, the present invention comprises a kit that comprises a unit package (e.g., a blister pack) enclosing one or more pharmaceutical dosage units, a unit package opener, and directions for using the unit package opener to release a pharmaceutical dosage unit from the unit package.

What is claimed is:

1. A blister pack opener, which comprises,
a puncture mechanism, a top segment and a base segment, at least a portion of said top segment and said base segment being rigidly connected to one another,
said base segment having an indentation therein which is of a size to receive a blister pack well that encloses a pharmaceutical dosage unit, and said top segment having said puncture mechanism located thereon,
wherein said puncture mechanism is shaped to have a larger perimeter than the perimeter of said pharmaceutical dosage unit and further shaped to nest within said indentation,
wherein said top segment or said base segment comprise a flexible material.

2. The blister pack opener of claim 1, wherein said top segment or said base segment, or both, comprise a flexible material.

3. The blister pack opener of claim 1, wherein application of manual pressure to said top segment or said base segment, or both, results in bringing at least a portion of said puncture mechanism into said indentation.

4. The blister pack opener of claim 1, wherein application of manual pressure to said top segment or said base segment, or both, results in flexion near a distal end of said top segment or said base segment, or both, thereby bringing at least a portion of said puncture mechanism into said indentation.

5. The blister pack opener of claim 1, wherein application of manual pressure to said top segment or said base segment, or both, results in bringing the puncture mechanism into contact with and cutting the blister pack backing, such that said blister pack backing is pierced.

6. The blister pack opener of claim 5, wherein said pharmaceutical dosage unit is released from said blister pack.

7. The blister pack opener of claim 1, wherein application of manual pressure to said top segment or said base segment, or both, results in flexion near a distal end of said top segment or said base segment, or both, thereby bringing the puncture mechanism into contact with and cutting the blister pack backing, such that said blister pack backing is pierced.

8. The blister pack opener of claim 7, wherein said pharmaceutical dosage unit is released from said blister pack.

9. The blister pack opener of claim 1, wherein said blister pack opener comprises two blister pack puncturing units, wherein said top segment and said base segment are rigidly connected to one another at the midpoint of said top segment and said base segment, and wherein said base segment has an indentation located at each distal end, and said top segment has a puncture mechanism located at each distal end.

10. The blister pack opener of claim 9, wherein said blister pack opener comprises a first puncture mechanism and a second puncture mechanism, wherein said first puncture mechanism has a first perimeter and said second puncture mechanism has a second perimeter of a different size than the first perimeter, whereby said first perimeter and said second perimeter enable said first puncture mechanism and said second puncture mechanism to release pharmaceutical dosage units of different sizes.

11. The blister pack opener of claim 10, wherein said puncture mechanism comprises a material of strength greater than the strength of said blister pack backing, the strength selected to puncture said blister pack backing.

12. The blister pack opener of claim 11, wherein said puncture mechanism has a cutting edge.

13. The blister pack opener of claim 12, wherein said puncture mechanism has one or more protrusions to enhance puncturing of said blister pack backing.

14. The blister pack opener of claim 13, wherein said protrusions have blunted ends.

15. The blister pack opener of claim 12, wherein said puncture mechanism has a circular shape.

16. The blister pack opener of claim 15, wherein said top segment or said base segment, or both, have one or more protrusions to enhance positioning of a blister pack when said opener is in use.

17. The blister pack opener of claim 16, wherein said top segment and said base segment comprise plastic.

18. The blister pack opener of claim 17, wherein said indentation has a flat bottom.

19. The blister pack opener of claim 18, wherein said indentation has a circular shape.

20. A blister pack opener, which comprises,
a puncture mechanism, a top segment and a base segment, at least a portion of said top segment and said base segment being rigidly connected to one another,
said base segment having an indentation therein which is of a size to receive a blister pack well that encloses a pharmaceutical dosage unit, and said top segment having said puncture mechanism located thereon,
said puncture mechanism having a metal cutting edge and having one or more protrusions with blunted ends to enhance puncturing of said blister pack backing,
wherein said puncture mechanism is circular and is shaped to have a larger perimeter than the perimeter of said pharmaceutical dosage unit and further shaped to nest within said indentation,
wherein said indentation has a circular shape and a flat bottom,
wherein said top segment or said base segment, or both, comprise a flexible plastic material,
wherein said top segment or said base segment, or both, have one or more protrusions to enhance positioning of a blister pack when said opener is in use, and
wherein application of manual pressure to said top segment or said base segment, or both, results in flexion near a distal end of said top segment or said base segment, or both, thereby bringing the puncture mechanism into contact with and cutting the blister pack backing, such that said blister pack backing is pierced.

21. The blister pack opener of claim 20, wherein said pharmaceutical dosage unit is released from said blister pack.

22. A method of opening a blister pack, said method comprising
a) placing a blister pack into a device comprising
i) a puncture mechanism, a top segment and a base segment, at least a portion of said top segment and said base segment being rigidly connected to one another,
ii) said base segment having an indentation therein which is of a size to receive a blister pack well that encloses a pharmaceutical dosage unit, and said top segment having said puncture mechanism located thereon,
iii) wherein said puncture mechanism is shaped to have a larger perimeter than the perimeter of said pharmaceutical dosage unit and further shaped to nest within said indentation,
iv) wherein said top segment or said base segment, or both, comprise a flexible material,
wherein said blister pack is placed into said device such that said blister pack well is placed within said indentation of said device, and
b) applying manual pressure to said top segment or said base segment, or both, of said device, and
c) bringing said puncture mechanism into contact with and cutting the blister pack backing, such that said blister pack backing is pierced.

23. The blister pack opener of claim 22, wherein said pharmaceutical dosage unit is released from said blister pack.

24. The blister pack opener of claim 23, wherein application of manual pressure to said top segment or said base segment, or both, results in bringing at least a portion of said puncture mechanism into said indentation.

25. The blister pack opener of claim 24, wherein said pharmaceutical dosage unit is released from said blister pack.

26. The blister pack opener of claim 25, wherein application of manual pressure to said top segment or said base segment, or both, results in flexion near a distal end of said top segment or said base segment, or both, thereby bringing at least a portion of said puncture mechanism into said indentation.

27. The blister pack opener of claim 26, wherein said pharmaceutical dosage unit is released from said blister pack.
